(19) United States
(12) Patent Application Publication
(10) Pub. No.: US 2009/0079727 A1
(43) Pub. Date: Mar. 26, 2009

(54) Display device and display driving method

(75) Inventor: Atsushi Ozawa, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/222,859

(22) Filed: Aug. 18, 2008

(30) Foreign Application Priority Data
Sep. 26, 2007 (JP) 2007-248752

(51) Int. Cl. G09G 5/00; G09G 3/32

(52) U.S. Cl. 345/214; 345/76

(57) ABSTRACT

Disclosed herein is a display device including a display panel section; a panel temperature detecting section; a voltage change amount determining section; a signal amplitude reference voltage varying section; and a signal value reference voltage generating section.

### CROSS REFERENCES TO RELATED APPLICATIONS

The present invention contains subject matter related to Japanese Patent Application JP 2007-248752 filed in the Japan Patent Office on Sep. 26, 2007, the entire contents of which being incorporated herein by reference.

### BACKGROUND OF THE INVENTION

1. Field of the Invention

The present invention relates to a display device using an organic electroluminescent element (organic EL element) as a light emitting element, and a display driving method of the display device.

2. Description of the Related Art

Flat panel displays are widespread in products such as computer displays, portable terminals, television receivers and the like. While liquid crystal display panels are mainly used in many cases at present, a narrow viewing angle and slow response speed of the liquid crystal display panel still continue being pointed out. On the other hand, an organic electroluminescence (hereinafter EL) display formed by a self-luminous element can overcome the problems of the viewing angle and the response described above, and achieve a thin form not desiring a backlight, high luminance, and high contrast. There are thus expectations for the organic EL display as a next-generation display device to supersede the liquid crystal display.

As with the liquid crystal display, there are a simple matrix system and an active matrix system as driving systems of the organic EL display. The former system offers a simple structure, but presents for example a problem of difficulty in realizing a large and high-definition display. Therefore, the active matrix system is now being actively developed. This active matrix system controls a current flowing through a light emitting element within each pixel circuit by an active element (typically a thin-film transistor (TFT)) provided within the pixel circuit.

### SUMMARY OF THE INVENTION

An organic EL element emits light at a luminance corresponding to a current applied to the organic EL element. A desired light emission luminance can be obtained by controlling the current passed through the organic EL element according to a signal value as a video signal. For this, it suffices for the above-described active element (TFT) to function as a source of a constant current corresponding to the signal value of the video signal. Specifically, a signal value voltage is written as gate-to-source voltage of the TFT (driving transistor) which functions as constant-current source by operation in a saturation region, and a current corresponding to the gate-to-source voltage is passed through the organic EL element.

It is known that the I-V characteristic (current-voltage characteristic) of the organic EL element varies according to temperature.

Thus, even when driving by the constant current corresponding to the signal value is to be performed, variation in the gate-to-source voltage is caused by the characteristic of variation in voltage across the organic EL element (anode-to-cathode voltage) according to the temperature. This appears as variation in amount of current, that is, variation in light emission luminance.

Thus, the display device using the organic EL element has a problem of luminance varying according to the temperature.

As methods for such a problem, there are techniques cited in Japanese Patent Laid-Open No. 2005-265937 (hereinafter referred to as Patent Document 1) and Japanese Patent Laid-Open No. 2003-330419 (hereinafter referred to as Patent Document 2), for example.

The above-mentioned Patent Document 1 describes a technique of suppressing variation in average light emission luminance by keeping a product of a current value and an emission period constant even when the current value is changed due to a change in use environment temperature of an organic EL element or variation in driving power supply voltage. This technique is intended to correct luminance variation by a pulse duty given to a driving transistor.

However, the pulse duty for an organic EL display is a parameter often used for various processing because the pulse duty allows a gradation component to be generated or allows response speed to be changed, and enables luminance to be controlled easily. The use of this parameter for fault correction leads to a limitation on the use of these controls.

Patent Document 2 describes a technique that allows the luminance of a panel to be adjusted by correcting display data so as to attain proper luminance from a detected ambient temperature.

In this case, considering merely luminance, proper correction can be made. However, the gradation component of the display data is used for the correction. The gradation component of video is reduced, and it is thus difficult to maintain high picture quality.

Thus, when the characteristic of luminance variation according to the temperature is to be corrected, the existing techniques do not provide fundamental measures against a cause of the occurrence of the luminance variation, but perform correcting operation by occupying a part of another parameter that can change luminance, such as a pulse duty, a video signal or the like. Therefore the component of added value such as picture quality, functionality or the like has to be reduced.

Accordingly, the embodiments of the present invention focus on the operation of pixel circuits, and propose a technique that enables luminance variation according to the temperature to be corrected easily by correcting a fundamental operation while maintaining high picture quality without using any other parameter related to picture quality.

According to an embodiment of the present invention, there is provided a display device including a display panel section using an organic electroluminescent element as a light emitting element in each pixel circuit, and driving the organic electroluminescent element in each pixel circuit such that the organic electroluminescent element emits light at a luminance corresponding to a voltage difference between a signal value voltage based on an input display data signal and a signal amplitude reference voltage; a panel temperature detecting section configured to detect temperature information of the display panel section; a voltage change amount determining section configured to determine an amount of voltage change according to the temperature information detected by the panel temperature detecting section; a signal amplitude reference voltage varying section configured to change a voltage value of the signal amplitude reference voltage to be supplied to each pixel circuit of the display panel section on a basis of the amount of voltage change determined by the voltage change amount determining section; and a signal value reference voltage generating section configured to generate a signal value reference voltage serving as a reference when the display panel section generates the signal value voltage based on the display data signal, and change a voltage value of the signal value reference voltage on the basis of the amount of voltage change determined by the voltage change amount determining section and supply the signal value reference voltage to the display panel section.

In addition, the voltage change amount determining section determines the amount of voltage change according to the temperature information detected by the panel temperature detecting section so as to change the signal amplitude reference voltage and the signal value reference voltage by a same amount and in a same direction as a variation according to temperature in amount of rise of anode potential at a time of a start of light emission of the organic electroluminescent element.

In addition, the voltage change amount determining section is supplied with information on an upper limit of the signal amplitude reference voltage, and determines the amount of voltage change in a range not exceeding the upper limit.

According to another embodiment of the present invention, there is provided a display driving method of a display device, the display device having a display panel section using an organic electroluminescent element as a light emitting element in each pixel circuit, and driving the organic electroluminescent element in each pixel circuit such that the organic electroluminescent element emits light at a luminance corresponding to a voltage difference between a signal value voltage based on an input display data signal and a signal amplitude reference voltage, the display driving method including: a step of detecting temperature information of the display panel section; a step of determining an amount of voltage change according to the detected temperature information; a step of changing a voltage value of the signal amplitude reference voltage to be supplied to each pixel circuit of the display panel section on a basis of the determined amount of voltage change; and a step of generating a signal value reference voltage serving as a reference when the display panel section generates the signal value voltage based on the display data signal, and changing a voltage value of the signal value reference voltage on the basis of the determined amount of voltage change and supplying the signal value reference voltage to the display panel section.

The embodiments of the present invention vary the signal amplitude reference voltage (Vofs voltage determining the black level of video signal amplitude) and the signal value reference voltage (γ reference voltages) for determining the amplitude of a signal value to be supplied to the pixel circuit according to temperature conditions.

Specifically, by merely performing up-and-down interlocked control of the signal amplitude reference voltage (Vofs voltage) and the signal value reference voltage (γ reference voltages) while maintaining an initial potential relation without changing a video signal (display data signal) or a pulse duty at all, it is possible to cancel the characteristic of luminance variation according to the temperature while maintaining the light emission display performance of the pixel circuit.

A voltage across an organic EL element rises immediately after a start of light emission as a result of application of a current to the organic EL element. However, a degree of rise in the voltage across the organic EL element (bootstrap amount) at the time of the current application varies according to temperature due to the temperature dependence of the I-V characteristic of the organic EL element. The interlocked control of the signal amplitude reference voltage (Vofs voltage) and the signal value reference voltage (γ reference voltages) is intended to hold constant the gate-to-source voltage of a driving transistor as a constant-current source supplying a current to the organic EL element even when the rise in the voltage across the organic EL element at the time of the light emission varies according to the temperature. Because the gate-to-source voltage of the driving transistor is held constant, the amount of the current flowing through the organic EL element can be made constant. That is, variation in light emission luminance according to the temperature can be eliminated.

According to the embodiments of the present invention, the signal amplitude reference voltage (Vofs voltage) and the signal value reference voltage (γ reference voltages) are controlled while the temperature is detected and the voltage across the organic EL element which voltage varies according to the temperature is grasped. Therefore the gate-to-source voltage of the driving transistor at the time of a start of light emission can be controlled to be constant irrespective of the temperature. There is thus an effect of being able to correct the temperature characteristic of luminance while maintaining picture quality performance without changing a video signal or a pulse duty at all.

### BRIEF DESCRIPTION OF THE DRAWINGS

FIG. 1 is a block diagram of a configuration of a display device according to the embodiments of the present invention;

FIG. 2 is a diagram of assistance in explaining an organic EL display panel module according to the embodiment;

FIG. 3 is a diagram of assistance in explaining a pixel circuit according to the embodiment;

FIGS. 4A to 4H are diagrams of assistance in explaining the operation of the pixel circuit according to the embodiment;

FIG. 5 is a diagram of assistance in explaining an amplitude reference voltage varying unit according to the embodiment;

FIG. 6 is a diagram of assistance in explaining the I-V characteristic of an organic EL element;

FIG. 7 is a diagram of assistance in explaining the characteristic of a voltage across the organic EL element;

FIG. 8 is a diagram of assistance in explaining variation in gate-to-source voltage due to variation in bootstrap amount according to temperature;

FIG. 9 is a diagram of assistance in explaining an operation of maintaining a gate-to-source voltage irrespective of temperature change according to the embodiment;

FIG. 10 is a diagram of assistance in explaining the light emission start voltage of the organic EL element; and

FIG. 11 is a diagram of assistance in explaining an example of voltage control according to the embodiment.

### DETAILED DESCRIPTION OF THE PREFERRED EMBODIMENTS

Preferred embodiments of a display device and a display driving method according to the present invention will hereinafter be described.

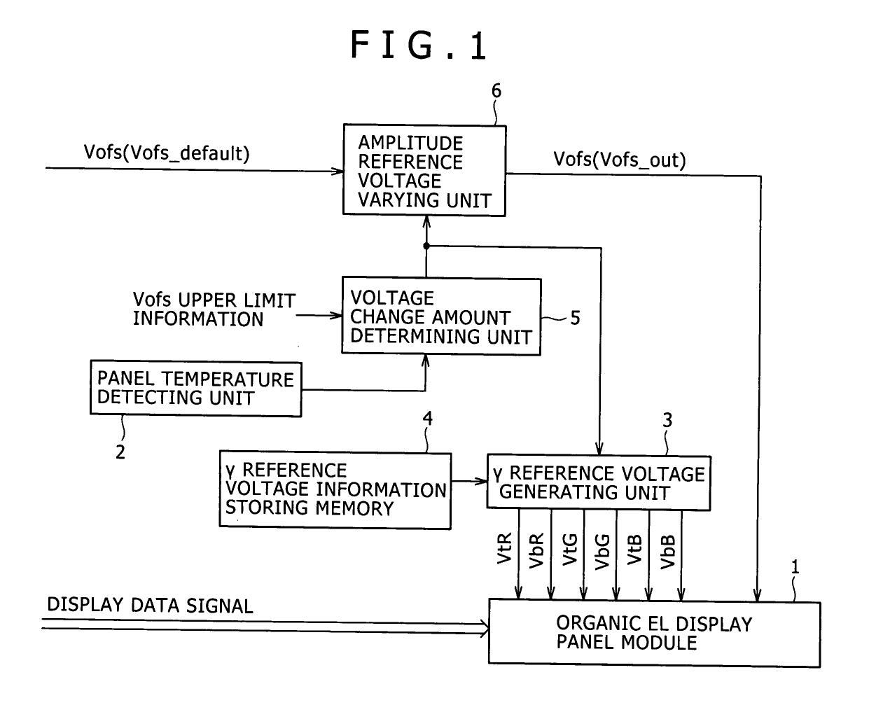

FIG. 1 shows a configuration of a display device according to the embodiments. The display device in the present example includes an organic EL display panel module 1 using an organic EL element as a light emitting element, a panel temperature detecting unit 2, a γ reference voltage generating unit 3, a γ reference voltage information storing memory 4, a voltage change amount determining unit 5, and an amplitude reference voltage varying unit 6.

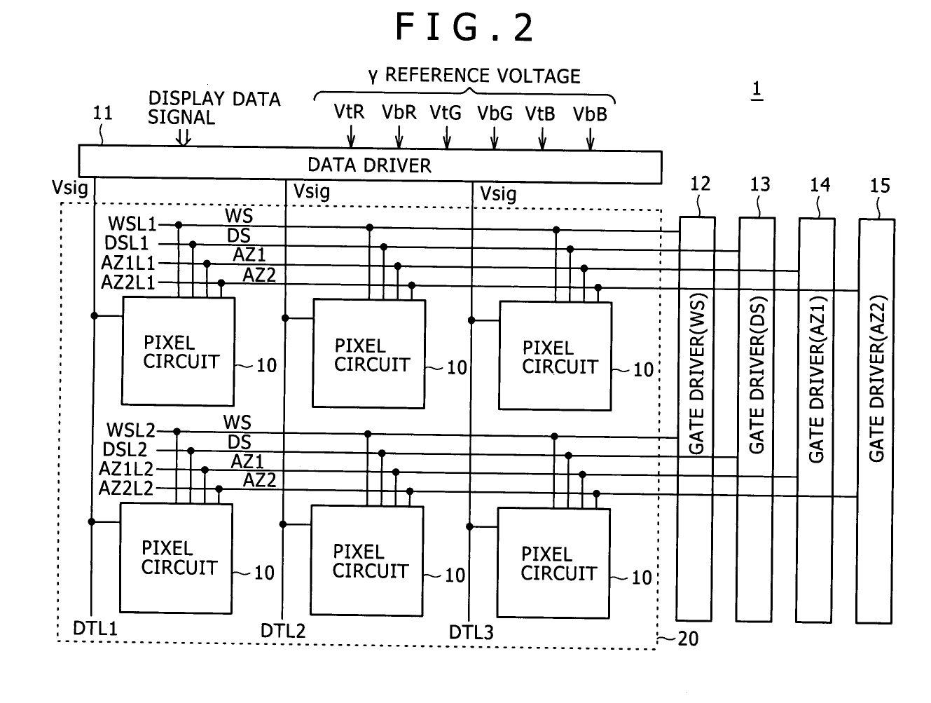

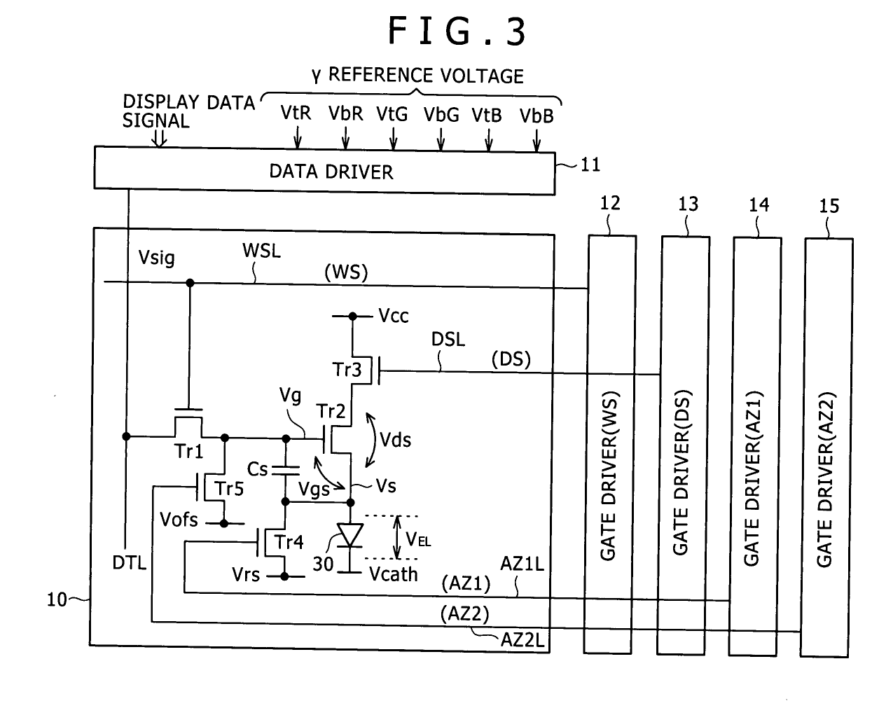

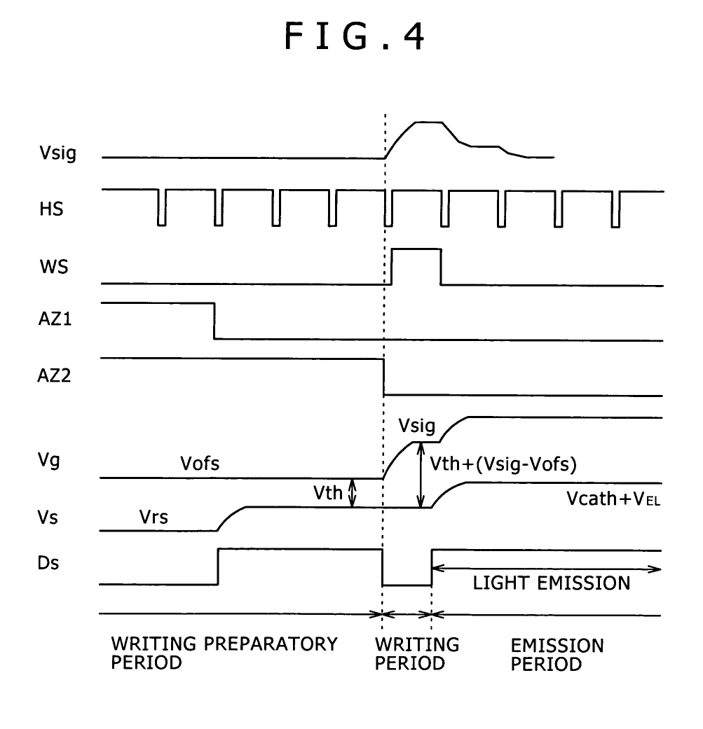

The organic EL display panel module 1 will first be described with reference to FIG. 2, FIG. 3, and FIG. 4.

FIG. 2 shows an example of configuration of the organic EL display panel module 1. The organic EL display panel module 1 includes pixel circuits 10 using an organic EL element as a light emitting element and performing light emission driving by an active matrix system.

As shown in FIG. 2, the organic EL display panel module 1 includes a pixel array unit 20 in which the pixel circuits 10 are arranged in the form of a matrix in a column direction and a row direction; a data driver 11; and gate drivers 12, 13, 14, and 15.

In addition, signal lines DTL1, DTL2, . . . supplying a signal value Vsig selected by the data driver 11 and corresponding to a display data signal supplied to the organic EL display panel module 1 as an input signal to be input to a pixel circuit 10 are arranged in the column direction of the pixel array unit 20. The signal lines DTL1, DTL2, . . . are arranged in a number equal to the number of columns of the pixel circuits 10 that are matrix-arranged in the pixel array unit 20.

In addition, arranged in the row direction of the pixel array unit 20 are scanning lines WSL1, WSL2, . . . , scanning lines DSL1, DSL2, . . . , scanning lines AZ1L1, AZ1L2, . . . , and scanning lines AZ2L1, AZ2L2, . . . . The scanning lines WSL, DSL, AZ1L, and AZ2L are each arranged in a number equal to the number of rows of the pixel circuits 10 that are matrix-arranged in the pixel array unit 20.

The scanning lines WSL (WSL1, WSL2, . . . ) are scanning lines for writing signal values Vsig to the pixel circuits 10 (write scan). The scanning lines WSL (WSL1, WSL2, . . . ) are driven by the gate driver 12. The gate driver 12 sequentially supplies a scanning pulse WS to each of the scanning lines WSL1, WSL2, . . . arranged in the form of rows in set predetermined timing, and thereby performs line-sequential scanning of the pixel circuits 10 in row units.

The scanning lines DSL (DSL1, DSL2, . . . ) are driven by the gate driver 13. The gate driver 13 supplies a scanning pulse DS for light emission driving of organic EL elements to each of the power supply lines DSL1, DSL2, . . . arranged in the form of rows in predetermined timing.

The scanning lines AZ1L (AZ1L1, AZ1L2, . . . ) are driven by the gate driver 14. The gate driver 14 supplies a scanning pulse AZ1 for supplying a reset voltage (Vrs) for pixel circuits 10 to each of the scanning lines AZ1L1, AZ1L2, . . . arranged in the form of rows in predetermined timing.

The scanning lines AZ2L (AZ2L1, AZ2L2, . . . ) are driven by the gate driver 15. The gate driver 15 supplies a scanning pulse AZ2 for supplying a signal amplitude reference voltage (Vofs) for pixel circuits 10 to each of the scanning lines AZ2L1, AZ2L2, . . . arranged in the form of rows in predetermined timing.

The data driver 11 supplies the signal lines DTL1, DTL2, . . . arranged in the column direction with a signal value (Vsig) as an input signal to a pixel circuit 10 according to line-sequential scanning by the gate driver 12.

The data driver 11 generally adopts a method in which the data driver 11 receives a reference voltage for determining an output voltage level (level of a signal value Vsig) corresponding to a gradation, and then performs D/A conversion. This reference voltage is referred to as a γ reference voltage.

In general purpose use, for each single color, a minimum of two kinds of analog voltages for determining output voltages at the time of a 0% gradation and at the time of a 100% gradation are input, and intermediate gradations are interpolated by a certain characteristic (generally a linear characteristic in the case of an organic EL display device).

In the example of FIG. 2, it is shown that γ reference voltages VtR, VbR, VtG, VbG, VtB, and VbB are input to the data driver 11, and that these γ reference voltages VtR, VbR, VtG, VbG, VtB, and VbB determine output voltages Vt (VtR, VtG, and VtB) at the time of a 100% gradation and output voltages Vb (VbR, VbG, and VbB) at the time of a 0% gradation for respective RGB colors.

The data driver 11 thus determines the output voltages Vt at the time of the 100% gradation and the output voltages Vb at the time of the 0% gradation for the respective colors by the γ reference voltages, and then outputs signal values Vsig as voltage values corresponding to gradation values of the respective colors of R, G, and B, which gradation values are indicated by an input display data signal, in ranges of the output voltages Vt to Vb.

Incidentally, a relatively large number of organic EL display devices have a few intermediate input points for a somewhat free γ characteristic correction as well as two points at the time of the 100% gradation and at the time of the 0% gradation. However, the principles are the same. Gradations between two input points are interpolated by a linear characteristic or the like.

FIG. 3 shows a configuration of a pixel circuit 10. This pixel circuit 10 is matrix-arranged as with the pixel circuits 10 in the configuration of FIG. 2. Incidentally, for simplicity, FIG. 3 shows merely one pixel circuit arranged at a part where a signal line DTL intersects scanning lines WSL, DSL, AZ1L, and AZ2L.

There are various configurations conceivable for the pixel circuit 10 which configurations can be adopted as embodiments. In this example, however, the pixel circuit 10 includes an organic EL element 30 as a light emitting element, one storage capacitor Cs, and five thin film transistors (TFTs) as a sampling transistor Tr1, a driving transistor Tr2, a switching transistor Tr3, a resetting transistor Tr4, and a transistor Tr5 for setting an amplitude reference. Each of the transistors Tr1, Tr2, Tr3, Tr4, and Tr5 is an n-channel TFT.

The storage capacitor Cs has one terminal connected to the source of the driving transistor Tr2, and has another terminal connected to the gate of the same driving transistor Tr2.

The light emitting element of the pixel circuit 10 is for example an organic EL element 30 of a diode structure, and has an anode and a cathode. The anode of the organic EL element 30 is connected to the source of the driving transistor Tr2. The cathode of the organic EL element 30 is connected to predetermined grounding wiring (cathode potential Vcath).

One terminal of the drain and the source of the sampling transistor Tr1 is connected to the signal line DTL. The other terminal of the drain and the source of the sampling transistor Tr1 is connected to the gate of the driving transistor Tr2. The gate of the sampling transistor is connected to the scanning line WSL.

One terminal of the drain and the source of the switching transistor Tr3 is connected to a power supply voltage Vcc. The other terminal of the drain and the source of the switching transistor Tr3 is connected to the drain of the driving transistor Tr2. The gate of the switching transistor Tr3 is connected to the scanning line DSL.

One terminal of the drain and the source of the resetting transistor Tr4 is connected to the source of the driving transistor Tr2. The other terminal of the drain and the source of the resetting transistor Tr4 is connected to a predetermined reset potential Vrs. The gate of the resetting transistor Tr4 is connected to the scanning line AZ1L.

One terminal of the drain and the source of the amplitude reference setting transistor Tr5 is connected to the gate of the driving transistor Tr2. The other terminal of the drain and the source of the amplitude reference setting transistor Tr5 is connected to a supply line for supplying a signal amplitude reference voltage Vofs. The gate of the amplitude reference setting transistor Tr5 is connected to the scanning line AZ2L.

The operation of such a pixel circuit 10 will be described briefly with reference to FIGS. 4A to 4H. FIG. 4A shows a signal value Vsig supplied to the signal line DTL. FIG. 4B shows a horizontal synchronizing signal HS. FIG. 4C shows a scanning pulse WS supplied from the scanning line WSL to the gate of the sampling transistor Tr1. FIG. 4D shows a scanning pulse AZ1 supplied from the scanning line AZ1L to the gate of the resetting transistor Tr4. FIG. 4E shows a scanning pulse AZ2 supplied from the scanning line AZ2L to the gate of the amplitude reference setting transistor Tr5. FIG. 4F shows a gate voltage Vg of the driving transistor Tr2. FIG. 4G shows a source voltage Vs of the driving transistor Tr2. FIG. 4H shows a scanning pulse DS supplied from the scanning line DSL to the gate of the switching transistor Tr3.

The horizontal synchronizing signal HS determines a point in time of a start of horizontal scanning. In a writing preparatory period in the figures, the resetting transistor Tr4 and the amplitude reference setting transistor Tr5 are made to conduct by the scanning pulses AZ1 and AZ2. Thereby, the gate voltage Vg of the driving transistor Tr2=the signal amplitude reference voltage Vofs, and the source voltage Vs of the driving transistor Tr2=the reset voltage Vrs. A potential difference between the signal amplitude reference voltage Vofs and the reset voltage Vrs is set sufficiently larger than the threshold voltage Vth of the driving transistor Tr2.

Next, in predetermined timing, the scanning pulse AZ1 is set to an L level, and the scanning pulse DS is set to an H level. That is, the resetting transistor Tr4 is turned off, and the switching transistor Tr3 is turned on. Thus, the power supply voltage Vcc is applied to the drain of the driving transistor Tr2, and the source of the driving transistor Tr2 is disconnected from the reset voltage Vrs. At this time, a current flows between the drain and the source of the driving transistor Tr2, and the source voltage Vs of the driving transistor Tr2 gradually rises. Then, at a point in time when the gate-to-source voltage Vgs of the driving transistor Tr2 reaches the threshold voltage Vth, the current that has been flowing between the drain and the source is stopped (cutoff state). The source voltage Vs is thereafter a potential to maintain a state in which the gate-to-source voltage Vgs is the threshold voltage Vth.

The gate-to-source voltage Vgs is thus set equal to the threshold voltage Vth in order to cancel effect of variations in threshold voltage Vth of each element.

In a subsequent writing period, the data driver 11 applies a signal value Vsig to the signal line DTL to write the signal value Vsig to the pixel circuit 10.

In this writing period, the scanning pulse DS is at an L level, so that the application of the power supply voltage Vcc is stopped. In addition, the scanning pulse AZ2 is at an L level, so that the fixation of the gate potential at the signal amplitude reference voltage Vofs is cancelled. Then, the sampling transistor Tr1 is made to conduct by the scanning pulse WS, whereby the signal value Vsig from the signal line DTL is written to the storage capacitor Cs.

In this writing period, the gate voltage of the driving transistor Tr2 rises according to the writing of the signal value Vsig to the storage capacitor Cs. Ultimately, the gate-to-source voltage Vgs of the driving transistor Tr2 becomes Vth+(Vsig−Vofs).

Following the writing period, operation in an emission period is performed. In the emission period, the scanning pulse WS is set to an L level, so that the sampling transistor Tr1 is turned off, while the switching transistor Tr3 is made to conduct by the scanning pulse DS. Thus, supplied with a current from the driving power supply voltage Vcc, the driving transistor Tr2 sends a current corresponding to a signal potential retained by the storage capacitor Cs (that is, the gate-to-source voltage of the driving transistor Tr2) through the organic EL element 30, so that the organic EL element 30 emits light. The driving transistor Tr2 operates in a saturation region, and functions as a constant-current source supplying the driving current corresponding to the signal value Vsig to the organic EL element 30.

Incidentally, because the current flows through the organic EL element 30, a voltage VEL across the organic EL element 30 rises. Thus, at the beginning of the emission period, the gate voltage Vg and the source voltage Vs of the driving transistor Tr2 correspondingly rise (bootstrap phenomenon). That is, the source voltage Vs rises to a potential of Vcath+VEL, and the gate voltage Vg rises while maintaining a potential difference of Vth+(Vsig−Vofs) from the source voltage Vs.

The light emission driving of the pixel circuit 10 is performed by the operation as described above.

Returning to FIG. 1, description will be made of the configuration of the present example.

A display data signal is supplied to the organic EL display panel module 1. The organic EL display panel module 1 performs, by the above-described configuration, the light emission driving of each pixel on the basis of the supplied display data signal.

The panel temperature detecting unit 2 detects a parameter corresponding to the temperature of the panel as temperature information. The panel temperature detecting unit 2 then outputs the temperature information to the voltage change amount determining unit 5.

The parameter of the temperature which parameter is detected as temperature information may be an actually measured value of an ambient temperature or the temperature of the organic EL display panel module 1, or may be another value such as a detected value of anode voltage of the organic EL element 30 in the above-described pixel circuit 10, or the like. That is, it suffices for the parameter to indicate temperature conditions directly or indirectly.

The voltage change amount determining unit 5 determines an amount of voltage change for the signal amplitude reference voltage Vofs and the γ reference voltages VtR, VbR, VtG, VbG, VtB, and VbB according to the temperature information input to the voltage change amount determining unit 5.

It is to be noted that the signal amplitude reference voltage Vofs and the γ reference voltages have a same amount of change and a same direction of change (a direction of voltage increase or a direction of voltage decrease). That is, one piece of voltage change amount information is determined according to the temperature information.

In addition, the amount of voltage change (including the direction of the change) is determined as a same amount and a same direction as a variation corresponding to the temperature in an amount of rise in anode potential (that is, a bootstrap amount of the source voltage Vs of the driving transistor Tr2 described above) at the time of a start of light emission of the organic EL element 30. Then, the information on the amount of change thus determined is supplied to the amplitude reference voltage varying unit 6 and the γ reference voltage generating unit 3.

However, Vofs upper limit information is input to the voltage change amount determining unit 5. The voltage change amount determining unit 5 determines the amount of voltage change strictly in a range where the signal amplitude reference voltage Vofs does not exceed the value of the Vofs upper limit information.

That is, the smaller of the information on the amount of voltage change calculated according to the temperature and voltage change amount information corresponding to the Vofs upper limit information is selected, and then output to the amplitude reference voltage varying unit 6 and the γ reference voltage generating unit 3.

The amplitude reference voltage varying unit 6 converts a signal amplitude reference voltage Vofs set as a predetermined initial voltage value (Vofs_default) into a voltage value (Vofs_out). The amplitude reference voltage varying unit 6 then outputs the voltage value (Vofs_out) to the organic EL display panel module 1. The signal amplitude reference voltage Vofs (Vofs_out) output from the amplitude reference voltage varying unit 6 is supplied so as to be common to all the pixel circuits 10 of the organic EL display panel module 1.

The amplitude reference voltage varying unit 6 subjects the initial voltage value (Vofs_default) input to the amplitude reference voltage varying unit 6 to voltage conversion (addition or subtraction of a voltage value) according to the information on the amount of voltage change determined by the voltage change amount determining unit 5. The amplitude reference voltage varying unit 6 then supplies the converted voltage value (Vofs_out) as signal amplitude reference voltage Vofs to the organic EL display panel module 1.

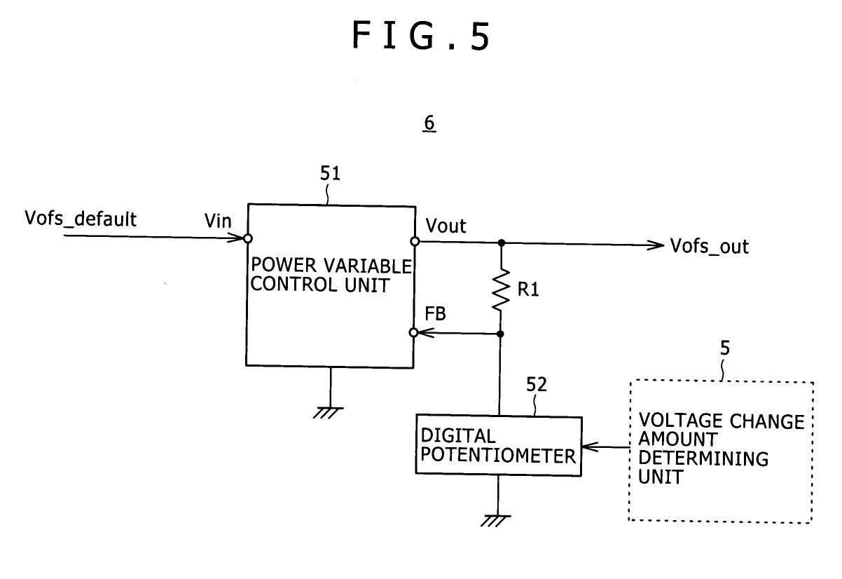

FIG. 5 shows an example of configuration of the amplitude reference voltage varying unit 6. For example, as shown in FIG. 5, the amplitude reference voltage varying unit 6 includes a power variable control unit 51, a digital potentiometer 52, and a resistance R1.

The power variable control unit 51 obtains an output voltage Vout resulting from voltage variation of an input voltage Vin.

Typical power variable control circuits are roughly classified into switching regulators and series regulators. However, methods of variably controlling the output voltage Vout are basically the same. When a relatively large amount of voltage change is desired to be obtained, a switching regulator is selected in relation to efficiency in most cases.

The power variable control unit 51 is provided with an FB terminal for feeding back the output voltage at a certain potential. The output voltage is stabilized by an operation to maintain the potential at a certain value. Because the FB potential is generally about 1 to 3 V, the output voltage is divided by resistance, and then connected to the FB terminal, whereby voltage variable control is made possible.

That is, because the FB potential is fixed at a certain value (for example 2 V), it suffices to change a ratio of resistance type voltage division in order to vary the output voltage.

For this, a fixed resistance R1 is used on one side, and a digital potentiometer 52 that can perform variable digital control of a resistance value is used on another side. The information on the amount of voltage change calculated by the voltage change amount determining unit 5 is supplied to the digital potentiometer 52 to variably control the resistance value. A signal amplitude reference voltage Vofs having the voltage value Vofs_out is thereby obtained as output voltage Vout resulting from adding or subtracting the amount of voltage change to or from the initial voltage value (Vofs_default). This signal amplitude reference voltage Vofs is supplied to each of the pixel circuits 10 of the organic EL display panel module 1.

The γ reference voltage generating unit 3 generates the above-described γ reference voltages VtR, VbR, VtG, VbG, VtB, and VbB, and then supplies the γ reference voltages VtR, VbR, VtG, VbG, VtB, and VbB to the organic EL display panel module 1 (data driver 11). The γ reference voltage generating unit 3 basically generates the γ reference voltages VtR, VbR, VtG, VbG, VtB, and VbB as voltage values based on information (for example initial set values as the γ reference voltages VtR, VbR, VtG, VbG, VtB, and VbB) stored in the γ reference voltage information storing memory 4.

However, as described above, the γ reference voltage generating unit 3 is supplied with the information on the amount of voltage change from the voltage change amount determining unit 5. The γ reference voltage generating unit 3 sets, as γ reference voltages VtR, VbR, VtG, VbG, VtB, and VbB to be actually supplied to the organic EL display panel module 1, voltage values obtained by adding or subtracting the amount of voltage change from the voltage change amount determining unit 5 to or from the default γ reference voltages VtR, VbR, VtG, VbG, VtB, and VbB generated on the basis of the information stored in the γ reference voltage information storing memory 4.

The γ reference voltages are generally generated by a general-purpose IC or the like. In general, the general-purpose IC is formed by packaging a D/A converter capable of digital control in a plurality of channel outputs. For example γ reference voltage information adjusted to an optimum value for each panel is stored in an NVM (Non-Volatile Memory) or the like. The information can be taken up and controlled by a digital value in the γ reference voltage generating IC. Such a general-purpose IC corresponds to the γ reference voltage generating unit 3 in FIG. 1. The NVM corresponds to the γ reference voltage information storing memory 4.

Thus, by variably controlling the digital value externally, it is possible to control the γ reference voltages. In the present example, by varying the digital value as the change amount information of the voltage change amount determining unit 5, the γ reference voltages VtR, VbR, VtG, VbG, VtB, and VbB output from the γ reference voltage generating unit 3 are variably controlled.

Then, variably controlling the γ reference voltages VtR, VbR, VtG, VbG, VtB, and VbB means varying the signal values Vsig output by the data driver 11 of the organic EL display panel module 1.

Description will be made of the operation of the display device in the present example as described above.

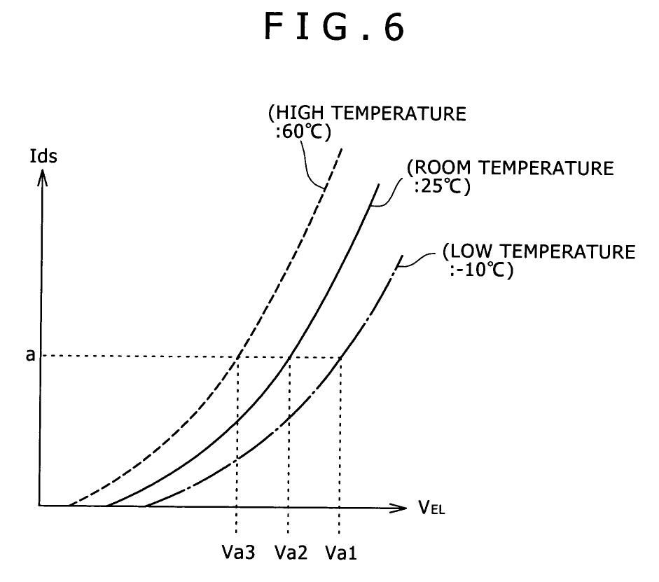

FIG. 6 shows variations caused by the temperature in I-V characteristic of the organic EL element 30. In this case, the characteristics of a current Ids flowing through the organic EL element and a voltage VEL across the organic EL element 30 at each of a high temperature (60° C.), room temperature (25° C.), and a low temperature (−10° C.) are shown.

The I-V characteristic of the organic EL element 30, that is, the characteristic of the voltage versus the current is changed to a low voltage side as the temperature is increased, and is changed to a high voltage side as the temperature is decreased.

For example, the voltage VEL (anode-to-cathode voltage) across the organic EL element 30 when the current Ids=a differs, such as voltages Va1, Va2, and Va3 in FIG. 6, depending on the temperature.

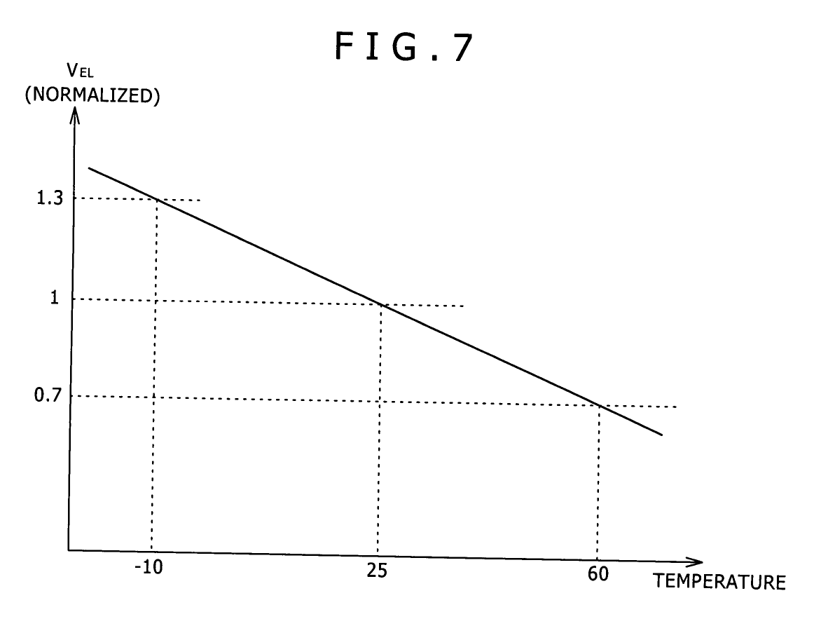

FIG. 7 shows an example of the characteristic of the voltage VEL across the organic EL element 30 when the parameter of an axis of abscissas is the temperature, the characteristic of the voltage VEL across the organic EL element 30 being obtained from the characteristic of FIG. 6. Incidentally, the voltage VEL across the organic EL element 30 of an axis of ordinates is a normalized value with the voltage VEL across the organic EL element 30 at 25° C. equal to one.

This figure shows that the voltage VEL across the organic EL element 30 changes with a substantially linear characteristic with respect to the temperature.

From such a characteristic, it is known as a common fact that the voltage across the organic EL element 30 at a time of light emission varies depending on the temperature. Depending on the configuration of the pixel circuit, an example of an adverse effect caused by this variation is luminance variation. A mechanism of the occurrence of this luminance variation will be described next.

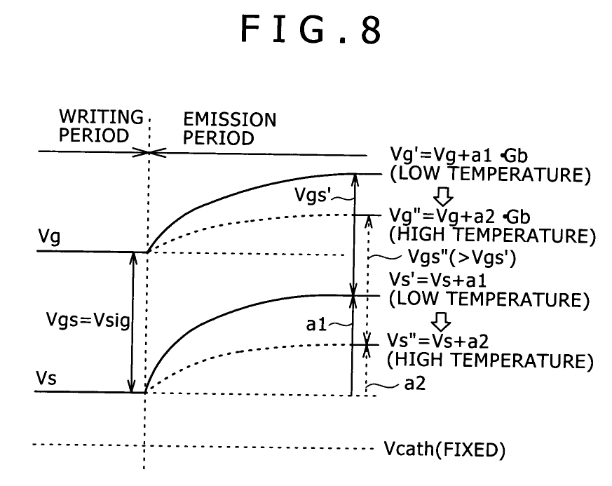

FIG. 8 is a diagram of assistance in explaining that a temperature variation in the voltage VEL across the organic EL element 30 causes a luminance variation.

FIG. 8 shows variation in the gate voltage Vg and the source voltage Vs of the driving transistor Tr2. This voltage variation occurs when a transition is made from the writing period to the emission period in the operation described with reference to FIGS. 4A to 4H.

In this case, a solid line represents a change in potential when the temperature of the organic EL element 30 is low. On the other hand, a broken line represents a change in potential when the temperature of the organic EL element 30 is high.

As shown in FIG. 8, as the light emission of the organic EL element 30 starts, a voltage VEL corresponding to a driving current occurs between the two electrodes of the organic EL element 30, and the source voltage Vs starts to rise. At this time, the gate voltage Vg also starts to rise in such a manner as to be pushed up by the rising source voltage Vs (bootstrap phenomenon).

However, a potential loss inevitably occurs when the source voltage Vs rises. The potential loss is caused by effect of a parasitic capacitance present around the storage capacitor Cs between the gate and the source of the driving transistor Tr2. That is, even when a change is to be made while the signal voltage Vsig is retained by the storage capacitor Cs, a part of charge retained by the storage capacitor Cs escapes into the parasitic capacitance.

Thus, a gate-to-source voltage Vgs′ after the source voltage Vs and the gate voltage Vg are pushed up by the bootstrap is lower than a gate-to-source voltage Vgs at a point in time of a start of the emission period (that is, the gate-to-source voltage Vgs set in the writing period).

This change in gate-to-source voltage Vgs can be expressed by the following equation when an amount of potential that can be retained in the storage capacitor Cs at the time of the potential rise in the emission period is represented by a gain Gb (<1).

Vgs′=Vgs−(1−Gb)·a

where the variable a represents the rise voltage of the source voltage Vs at the time of the potential rise. That is, the variable a is a value corresponding to the voltage VEL across the organic EL element 30.

The above equation indicates that the lower the rise voltage (variable a) of the source voltage Vs, the smaller the change in gate-to-source voltage Vgs after the start of the light emission.

The above equation also indicates that the temperature characteristic does not appear in screen luminance when the rise voltage (variable a) of the source voltage Vs is constant irrespective of the temperature.

However, as described with reference to FIG. 6 and FIG. 7, the voltage VEL between the two electrodes of the organic EL element 30 changes greatly at different temperatures even when the driving current Ids is the same. That is, the higher the temperature, the lower the voltage VEL.

Because a cathode potential Vcat applied to the cathode electrode (cathode) of the organic EL element 30 is fixed, a phenomenon occurs in which as shown in FIG. 8, the variable a giving the rise voltage of the source voltage Vs changes as the temperature becomes different.

Specifically, “a1” as the variable a in the case of a voltage change represented by a solid line and “a2” as the variable a in the case of a voltage change represented by a broken line are values different from each other. As a result, a comparison between a gate-to-source voltage Vgs′ in the case of the voltage change represented by the solid line (at the time of a low temperature) and a gate-to-source voltage Vgs″ in the case of the voltage change represented by the broken line (at the time of a high temperature) shows that Vgs′>Vgs′.

The organic EL element 30 emits light at a predetermined luminance by being supplied with a current corresponding to the gate-to-source voltage Vgs of the driving transistor Tr2.

Hence, a phenomenon occurs in which light emission luminance changes according to the temperature even when a signal voltage Vsig corresponding to same pixel data is written to the storage capacitor Cs.

In order to eliminate such a phenomenon in which the luminance changes according to the temperature, in the present embodiment, the signal amplitude reference voltage Vofs and the γ reference voltages are controlled up and down in such a manner as to be interlocked with each other by a same amount of change (and in a same direction of change) as a variation in bootstrap amount on the basis of the temperature characteristic of the voltage VEL across the organic EL element 30 according to the parameter corresponding to the detected panel temperature.

In particular, the above-described luminance change is due to variation in the variable a according to the temperature, and the variation in the variable a means variation in the voltage VEL across the organic EL element 30.

Accordingly, in the present example, the amount of change of the signal amplitude reference voltage Vofs and the γ reference voltages is controlled in relation to the temperature characteristic of the voltage VEL across the organic EL element 30 such that an amount by which the anode potential rises after a start of light emission is controlled to be constant and the gate-to-source voltage Vgs of the driving transistor Tr2 during the light emission is a same amount at all times without depending on the temperature.

Because the gate-to-source voltage Vgs of the driving transistor Tr2 during the light emission can be held constant in any temperature conditions, an amount of current flowing through the organic EL element 30 can be made constant.

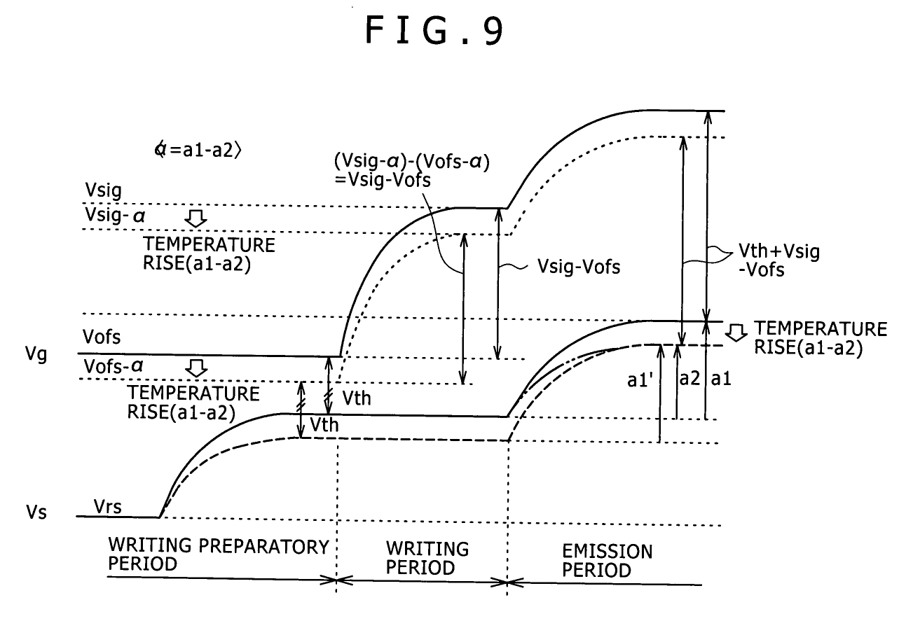

Such operation will be described with reference to FIG. 9.

FIG. 9 shows a potential ultimately retained as gate-to-source voltage Vgs when the signal amplitude reference voltage Vofs and the γ reference voltages are changed by the same amount and in the same direction as a temperature variation in the voltage VEL across the organic EL element 30.

A solid line represents changes in the gate voltage Vg and the source voltage Vs of the driving transistor Tr2 at a certain temperature (assumed to be at room temperature).

Though the voltage variation of the solid line has been described with reference to FIGS. 4A to 4H, the voltage variation will be described again briefly as follows.

A writing preparatory period first starts with a state in which the signal amplitude reference voltage Vofs is supplied to the gate (Vg) of the driving transistor Tr2 and the reset voltage Vrs is supplied to the source (Vs) of the driving transistor Tr2.

When the supply of the reset voltage Vrs to the source (Vs) of the driving transistor Tr2 is stopped, and the power supply voltage Vcc is supplied to the drain of the driving transistor Tr2, the source voltage Vs starts a gradual potential rise. When the gate-to-source voltage Vgs reaches the potential state of the threshold voltage Vth, a flow of drain-to-source current stops (cutoff state). Thereafter, the threshold voltage Vth is retained as the gate-to-source voltage Vgs.

In a writing period, the supply of the signal amplitude reference voltage Vofs to the gate (Vg) of the driving transistor Tr2 is stopped to change to the supply of the signal value Vsig. Thus, a “Vsig−Vofs” potential as well as the threshold voltage Vth thus far is added to the gate-to-source voltage Vgs.

Then, an emission period is started. At the beginning of the emission period, a bootstrap phenomenon accompanies the occurrence of the voltage VEL across the organic EL element 30. A voltage “Vth+(Vsig−Vofs)” is ultimately written as gate-to-source voltage Vgs. The bootstrap amount of the source potential at this time will be defined as a1.

In this case, suppose that the temperature has changed in a rising direction.

Suppose that as the voltage VEL across the organic EL element 30 has been lowered due to the temperature rise, the bootstrap amount of the source potential Vs at the beginning of the emission period becomes a2 in FIG. 9.

Doing nothing as in the conventional case at this time invites a rise in luminance as described above with reference to FIG. 8. That is, the source voltage Vs rises as represented by alternate long and short dash lines at the beginning of the emission period. As a result, the gate-to-source voltage Vgs increases, and thus the light emission luminance rises.

In order to avoid such a luminance variation, in the present example, when the temperature rises, the signal amplitude reference voltage Vofs and the γ reference voltages are changed in such a manner as to be interlocked with each other according to the temperature rise.

Variations in the gate voltage Vg and the source voltage Vs at the time of the temperature rise are represented by broken lines.

Let “α” be the amount of voltage change, and the amount of voltage change α=a1-a2. States when the signal amplitude reference voltage Vofs is changed to Vofs−α and when the signal value Vsig is changed to Vsig− by controlling the γ reference voltages are represented by the broken lines.

In the case of the broken lines, the signal amplitude reference voltage Vofs is lowered to “Vofs−α”. Therefore the source voltage Vs in the writing preparatory period is also lowered as compared with the case of the solid line. This is because the gate voltage Vg=Vofs−α and the source voltage Vs becomes stable at a point in time where the gate-to-source voltage Vgs becomes equal to the threshold voltage Vth in the writing preparatory period.

Then, in the writing period, the supply of the signal amplitude reference voltage Vofs−α to the gate (Vg) of the driving transistor Tr2 is stopped to change to the supply of the signal value Vsig (Vsig−α in this case). Thus, a “(Vsig−α)−(Vofs−α)” potential as well as the threshold voltage Vth thus far is added to the gate-to-source voltage Vgs. That is, a “Vsig−Vofs” potential is added to the gate-to-source voltage Vgs.

Then, when light emission is started, a bootstrap phenomenon accompanies the occurrence of the voltage VEL across the organic EL element 30 at the beginning of the light emission. The bootstrap amount of the source potential in this case is a1′ in FIG. 9. In this case, a1′=a1.

In the end, a voltage “Vth+(Vsig−Vofs)” is ultimately written as gate-to-source voltage Vgs.

That is, the amount of change (a1-a2) in bootstrap amount which change is caused by a variation in the voltage VEL across the organic EL element 30 according to the temperature is reflected in the signal amplitude reference voltage Vofs and the γ reference voltages in the same direction of the change, thereby, the final bootstrap amount of the source potential can be returned to the same amount as al before the temperature variation. Thus, the voltage retained as gate-to-source voltage Vgs during light emission can be controlled to be constant.

Incidentally, the example of the broken lines in FIG. 9 is a case of a temperature rise. However, in a case of a temperature fall, it suffices to conversely raise the signal amplitude reference voltage Vofs and the γ reference voltages by the amount of change (a1-a2) in bootstrap amount.

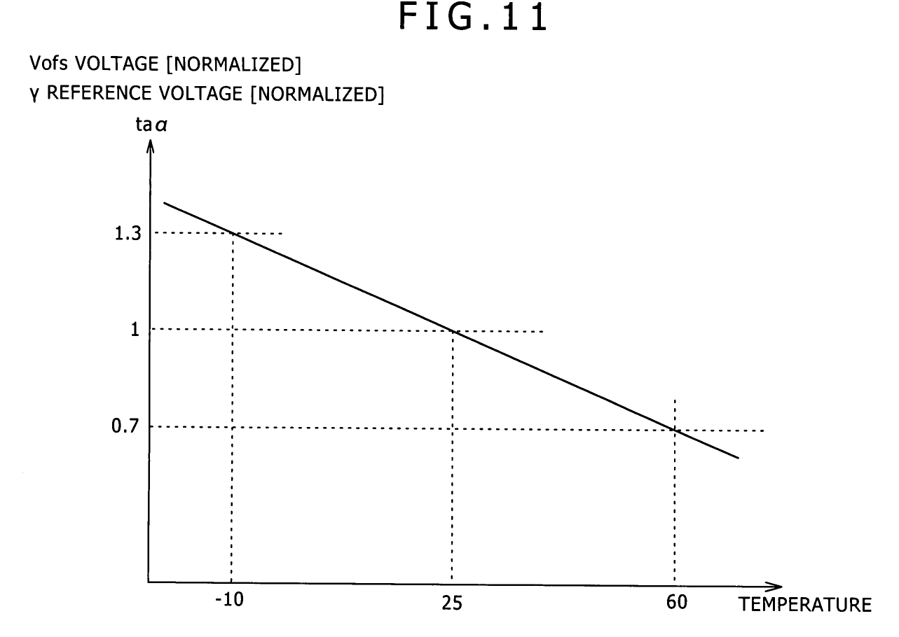

In order to enable the operation as described above, it suffices to change the signal amplitude reference voltage Vofs and the γ reference voltages by the same amount and in the same direction as the amount of change in the voltage VEL across the organic EL element 30 according to the temperature. This is shown in FIG. 11.

FIG. 11 shows a voltage value normalized with a voltage value at a temperature of 25° C., for example, set as “1”. The voltage change amount determining unit 5 calculates the amount of voltage change for thus controlling the signal amplitude reference voltage Vofs and the γ reference voltages according to temperature information, whereby the above-described operation is realized. That is, it suffices to supply the information on the amount of voltage change described above to the amplitude reference voltage varying unit 6 and the γ reference voltage generating unit 3, and control the signal amplitude reference voltage Vofs and the γ reference voltages VtR, VbR, VtG, VbG, VtB, and VbB.

Incidentally, it is necessary in this case not to raise the signal amplitude reference voltage Vofs too much. A potential Vofs−Vth is applied to the anode electrode of the organic EL element 30 during Vth characteristic cancelling operation in the writing preparatory period in pixel operation. When a current flows through the organic EL element in this state, correct Vth characteristic cancelling operation is hindered. It is thus necessary to be careful not to let the potential Vofs−Vth exceed the light emission start voltage of the organic EL element.

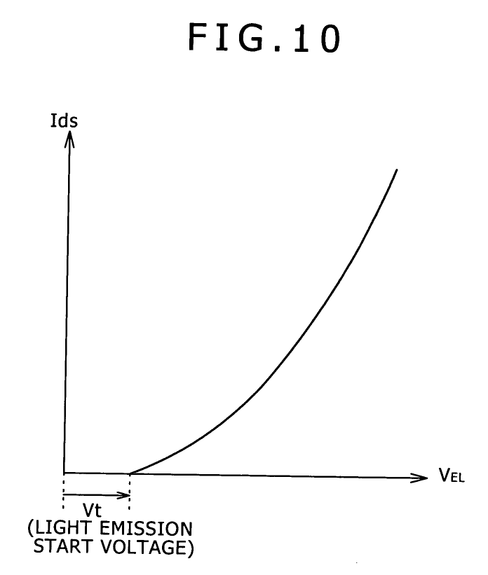

FIG. 10 shows the I-V characteristic of the organic EL element 30. When the voltage VEL across the organic EL element 30 exceeds the light emission start voltage Vt, a current starts to flow through the organic EL element 30.

Thus, the signal amplitude reference voltage Vofs needs to have an upper limit so that the potential Vofs−Vth does not exceed the light emission start voltage Vt of the organic EL element. Accordingly, as described above, the Vofs upper limit information as a result of consideration being given to this regard is set in the voltage change amount determining unit 5, and the signal amplitude reference voltage Vofs is varied (raised) in a range not exceeding the upper limit.

As described above, according to the present embodiment, the signal amplitude reference voltage Vofs and the signal value reference voltage (γ reference voltages) are controlled while the temperature is detected and the voltage across the organic EL element which voltage varies according to the temperature is grasped. Therefore the bootstrap amount of the source potential of the driving transistor Tr2 at the time of a start of light emission can be controlled to a fixed value irrespective of the temperature. As a result, the gate-to-source voltage of the driving transistor can be controlled to be constant irrespective of the temperature. There is thus an effect of being able to correct the temperature characteristic of luminance while maintaining picture quality performance without changing a video signal or a pulse duty at all.

In addition, while the control of the γ reference voltages is interlocked with the control of the signal amplitude reference voltage Vofs, no correction is made to the video signal (the gradation value of the display data signal) itself. Controlling luminance by varying the output voltage (signal voltage Vsig) of the data driver 11 by means of the γ reference voltages can be said to be a very useful method that ensures 100% gradation reproducibility.

In order to hold the bootstrap amount constant irrespective of the temperature, increasing and decreasing the cathode voltage of the organic EL element 30 is conceivable. In this case, however, it is necessary to control a high-capacity power supply such as a cathode power supply or the like. In contrast to this, the present example has an advantage of enabling reduction in circuit scale and making it possible to achieve the reduction in circuit scale easily.

Various examples of modification are conceivable as embodiments.

While the configuration of a pixel circuit in the organic EL display panel module 1 is shown in FIG. 3, the embodiments of the present invention are applicable to cases where a pixel circuit configuration other than that of FIG. 3 is adopted. The embodiments of the present invention are suitable especially for display devices that perform pixel driving by an active matrix system.

Specifically, the embodiments of the present invention are applicable to all pixel circuits in which the potential of a signal amplitude reference voltage Vofs is reproduced at the gate of a driving transistor and a potential Vofs−Vth is reproduced at the source of the driving transistor after an operation of cancelling the Vth characteristic of the driving transistor is performed, and then the potential of a signal value Vsig is supplied as a gate potential, whereby an operation of writing a potential “Vth+(Vsig−Vofs)” as gate-to-source voltage Vgs is performed.

It should be understood by those skilled in the art that various modifications, combinations, sub-combinations and alterations may occur depending on design requirements and other factor in so far as they are within the scope of the appended claims or the equivalents thereof.

What is claimed is:

1. A display device comprising:
a display panel section using an organic electroluminescent element as a light emitting element in each pixel circuit, and driving said organic electroluminescent element in each pixel circuit such that said organic electroluminescent element emits light at a luminance corresponding to a voltage difference between a signal value voltage based on an input display data signal and a signal amplitude reference voltage;
a panel temperature detecting section configured to detect temperature information of said display panel section;
a voltage change amount determining section configured to determine an amount of voltage change according to the temperature information detected by said panel temperature detecting section;
a signal amplitude reference voltage varying section configured to change a voltage value of said signal amplitude reference voltage to be supplied to each pixel circuit of said display panel section on a basis of the amount of voltage change determined by said voltage change amount determining section; and
a signal value reference voltage generating section configured to generate a signal value reference voltage serving as a reference when said display panel section generates the signal value voltage based on said display data signal, and change a voltage value of said signal value reference voltage on the basis of the amount of voltage change determined by said voltage change amount determining section and supply said signal value reference voltage to said display panel section.

2. The display device according to claim 1,
wherein said voltage change amount determining section determines the amount of voltage change according to the temperature information detected by said panel temperature detecting section so as to change said signal amplitude reference voltage and said signal value reference voltage by a same amount and in a same direction as a variation according to temperature in amount of rise of anode potential at a time of a start of light emission of said organic electroluminescent element.

3. The display device according to claim 1,
wherein said voltage change amount determining section is supplied with information on an upper limit of said signal amplitude reference voltage, and determines the amount of voltage change in a range not exceeding said upper limit.

4. A display driving method of a display device, said display device having a display panel section using an organic electroluminescent element as a light emitting element in each pixel circuit, and driving said organic electroluminescent element in each pixel circuit such that said organic electroluminescent element emits light at a luminance corresponding to a voltage difference between a signal value voltage based on an input display data signal and a signal amplitude reference voltage, said display driving method comprising the steps of:
detecting temperature information of said display panel section;
determining an amount of voltage change according to the detected temperature information;
changing a voltage value of said signal amplitude reference voltage to be supplied to each pixel circuit of said display panel section on a basis of the determined amount of voltage change; and
generating a signal value reference voltage serving as a reference when said display panel section generates the signal value voltage based on said display data signal, and changing a voltage value of said signal value reference voltage on the basis of the determined amount of voltage change and supplying said signal value reference voltage to said display panel section.

5. A display device comprising:
display panel means using an organic electroluminescent element as a light emitting element in each pixel circuit, and driving said organic electroluminescent element in each pixel circuit such that said organic electroluminescent element emits light at a luminance corresponding to a voltage difference between a signal value voltage based on an input display data signal and a signal amplitude reference voltage;
panel temperature detecting means for detecting temperature information of said display panel means;
voltage change amount determining means for determining an amount of voltage change according to the temperature information detected by said panel temperature detecting means;
signal amplitude reference voltage varying means for changing a voltage value of said signal amplitude reference voltage to be supplied to each pixel circuit of said display panel means on a basis of the amount of voltage change determined by said voltage change amount determining means; and
signal value reference voltage generating means for generating a signal value reference voltage serving as a reference when said display panel means generates the signal value voltage based on said display data signal, and changing a voltage value of said signal value reference voltage on the basis of the amount of voltage change determined by said voltage change amount determining means and supplying said signal value reference voltage to said display panel means.
